(19) United States
(12) Patent Application Publication
(10) Pub. No.: US 2017/0147016 A1
(43) Pub. Date: May 25, 2017

(54) NETWORK COMMUNICATION SYSTEM AND METHOD FOR THE SYNCHRONIZATION OF USER PREFERENCES

(71) Applicant: Raviteja Lingineni, Irving, TX (US)

(72) Inventor: Raviteja Lingineni, Irving, TX (US)

(21) Appl. No.: 14/947,841

(22) Filed: Nov. 20, 2015

(51) Int. Cl. G05D 23/19; G05B 15/02; H04L 12/28; H04L 29/08

(52) U.S. Cl. CPC G05D 23/1917; H04L 67/306; G05B 15/02; H04L 12/2816

(57) ABSTRACT

The present application includes a system and method of sharing and initiating an individual's preferences via one or more electronic control units, namely at least an identification unit, a control unit, and a system provider. The system includes network devices which allow individual preferences to be transferred to the control units automatically regardless of the control unit manufacture. Once an individual is identified through the identification unit, the control unit obtains user preferences from the system provider and implements one or more preferences. Licensing and fees are set by the system provider.

### BACKGROUND

1. Field of the Invention

The present application relates generally to a network communication system, in particular to automatic control.

2. Description of Related Art

The internet of things generally uses a combination of electronic hardware, sensors, actuators, software and network technology. The scope for the internet of things applications extend to the categories of home automation, automotive, but are not typically limited to them. Home applications usually include HVAC, lighting control, entertainment, and energy conservation. In addition to home use, applications can be found in the workplace, car, and even the shopping center.

A typical example of the use of home automation is a resident arriving home after work. During the day, when no one is home, the HVAC system and lighting may be set to reduce energy consumption. As the resident arrives and identifies themselves to the home automation system, the air temperature is set to what that household member prefers. Lights are turned on as they move from room to room. When they move to a room with an entertainment system, their favorite channels are automatically loaded into the TV or preferred music begins playing. The individuals identified may even be a guest or family pet.

Automation suppliers generally create compatible hardware within their product line. However, the product lines of suppliers, at different locations, fail to transfer or recognize common preferences as a user travels between locations. For example, the automation system of a person's home may not communicate with the same or similar type of automation system at a neighbor's home. In this case the user would typically have to separately set up their preferences at every individual location.

A similar problem may exist when the person rents a car. Preferences such as air temperature, radio station selection, seat position or GPS map destinations for their personal cars may not be available in the rental car because the rental car uses incompatible automation hardware.

It is desired that a system be developed to permit the personal preferences of an individual follow them as they go between locations and interact with different internet of things devices. For example, the transfer of information could be between the categories of home, commerce, health, or travel. This interaction is to be independent of the devices or systems being used at a particular location. The system and method being designed to allow for sharing of the user's preferences among various hardware platforms independent of location. The interaction being triggered and initiated through the detection of a unique identifier from a particular identification device. Although great strides have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is chart of a network communication system according to the preferred embodiment of the present application;

FIG. 2 is an exemplary schematic of an electronic device for use in the network communication system of FIG. 1;

FIG. 3 is a detailed chart showing an interaction between a user identification unit, a control unit, and a system provider in the network communication system of FIG. 1; and

FIG. 4 is a detailed chart showing an interaction between the user identification unit, the control unit, a supplier, and the system provider in the network communication system of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The system and method in accordance with the present application overcomes one or more of the above-discussed problems commonly associated with conventional automation methods. The system and method of sharing and initiating an individual's preferences via one or more electronic control units, according to the present application, is configured to make the initiation of personal preferences seamless to the individual. The system is designed such that that an individual carries or broadcasts a unique identifier wherever they go. As the individual comes within a selected proximity to the electronic control unit, the identification of the user is processed and the individual's personal preferences are applied through the electronic control unit. The individual is able to store various different personal preferences over the network through an online portal/system provider. These can be selectively accessed and transmitted to one or more electronic control units. A supplier or manufacturer may obtain source code from the system provider to integrate into each electronic control unit to permit its operation with various system platforms, making it platform independent. These and other unique features of the system and method are discussed below and illustrated in the accompanying drawings.

The system and method will be understood, both as to its structure and operation, from the accompanying drawings, taken in conjunction with the accompanying description. Several embodiments of the assembly are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The system includes one or more electronic devices in communication through a network that share an individual's preferences with a particular electronic device in order to make the initiation of personal preferences on the electronic device seamless to the individual. The system centers around three main components: an identification unit, a control unit, and a system provider. The identification unit broadcasts a unique user identifier to the control unit. The control unit receives the unique identifier and identifies the user. The control unit automatically applies selected user preferences, received through the system provider, for the user. The user may adjust, create, and delete personal preferences through an online portal permitting access to the system provider.

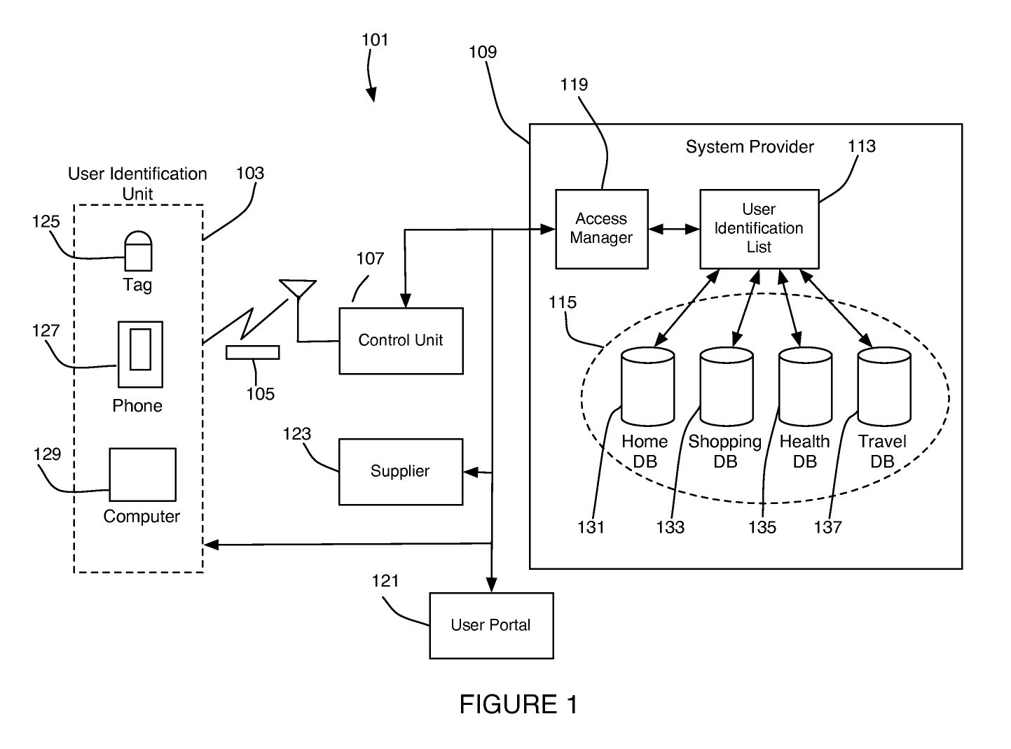

Referring now to the drawings wherein like reference characters identify corresponding or similar elements in form and function throughout the several views. FIG. 1 illustrates the system of the present application. System 101 is configured to share an individual's preferences and is configured make the initiation of personal preferences seamless to the individual. The system includes at least an identification unit 103, a control unit 107, and a system provider 109. User identification unit 103 is configured to broadcast a signal carrying a user identifier 105. User identifier 105 is uniquely assigned to a particular user. Control unit 107 is configured to receive user identifier 105 and selectively initiate an action as a result of one or more predefined user preferences particular to the user identified. System provider 109 is configured to store one or more user preferences and categorize the one or more user preferences into one or more databases 115. System provider 109 is in communication with control unit 107 for the selective communication of the one or more user preferences to control unit 107. Control unit 107 implements the one or more user preferences when it receives a recognized or valid user identifier 105.

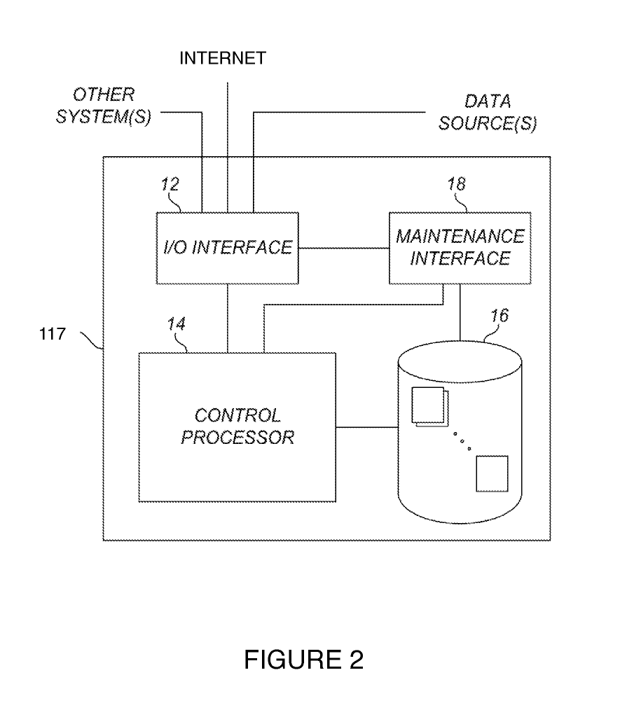

Referring now to FIG. 2 in the drawings, an exemplary schematic of any one of the electronic devices or systems within system 101 is illustrated. System 101 includes various electronic devices in communication with one another to carry out particular tasks. Each device is operable to carry out tasks on its own. FIG. 2 is a representation of what these devices may be configured to include and how they may operate. In particular, FIG. 2 is an exemplary representation of the structure associated with identification unit 103, control unit 107, and system provider 109. It is understood that the other components and devices are included within system 101 that may well be represented by this exemplary embodiment. It is also understood that the exemplary structure is not herein limiting to any portion of system 101.

The system 101 includes an input/output (I/O) interface 12, a control processor 14, a database 16, and a maintenance interface 18. Alternative embodiments can combine or distribute the input/output (I/O) interface 12, control processor 14, database 16, and maintenance interface 18 as desired. Embodiments of the system 101 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the system 101. The I/O interface 12 is in communication with the control processor 14 and database 16 and is configured to provide an interactive link between the buyer and other interested parties. The I/O interface 12 can be configured for allowing one or more users to input information to various devices within the system 101 via any known input device. Examples can include a keyboard, mouse, touch screen, microphone, and/or any other desired input device. The I/O interface 12 provides a display portal defining a plurality of visually perceptible elements corresponding to the prediction data. The I/O interface 12 can be configured for allowing one or more users to receive information output from any portion of the system 101 via any known output device. Examples can include a display monitor, a printer, a speaker, and/or any other desired output device. The I/O interface 12 can be configured for allowing other systems to communicate with the system 101 via any known wired or wireless transmissions, including WI-FI and BLUETOOTH. For example, the I/O interface 12 can allow one or more remote computer(s) to access information, input information, and/or remotely instruct any portion of the system 101 to perform one or more of the tasks described herein. The I/O interface 12 can be configured for allowing communication with one or more remote data sources. For example, the I/O interface 12 can allow one or more remote data source(s) to access information, input information, and/or remotely instruct portions of the system 101 to perform one or more of the tasks described herein.

The database 16 provides persistent data storage (computer readable storage media, i.e. hardware) for system 101. Database 16 is in communication with control processor 14 and I/O interface 12. While the term “database” is primarily used, a memory or other suitable data storage arrangement may provide the functionality of the database 16. In alternative embodiments, the database 16 can be integral to or separate from the system 101 and can operate on one or more computers. The database 16 preferably provides non-volatile data storage for any information suitable to support the operation of the system 101, including various types of data necessary to perform the functions and feature discussed below.

The maintenance interface 18 is configured to allow users to maintain desired operation of the system 101. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the control processor 14 and/or the I/O interface 12. This can include, for example, software updates and/or administrative tasks such as security management and/or adjustment of certain tolerance settings.

The control processor 14 can be configured to perform a process or a plurality of processes such as the processes described below in connection with the associated Figures. Additionally, control processor 14 includes software programmed to compile properly communicate with the interested parties. Processor 14 includes a non-transitory computer-readable medium with instructions stored thereon to execute predetermined steps. Various functions of the control processor 14 may be realized.

Referring again to FIG. 1 in the drawings, user identification unit 103 can communicate with system provider 109 to identify a user. Unit 103 is configured to transmit user identifier 105, that when received by control unit 107, one or more user preferences may be automatically initiated. Unit 103 may take the form of different types of technology. Each form is configured to at least transmit a signal. Examples of unit 103 can be any of the following: a tag 125, a portable phone 127, a computer 129, or any other electronic device capable of being assigned user identifier 105 and communicating user identifier 105 with control unit 107. User identifier 105 can be established by the user manually through the network by communicating directly with system provider 109. For example, the user may log into an account (via a user portal) located within system provider 109 and relate the particular unit 103 with the unique user identifier (user identifier 105). This user identifier is then assigned to unit 103. Conversely, user identifier 105 may be preassigned to unit 103 at the time of purchase and need only be activated.

Unit 103 is configured to continually broadcast identifier 105 and is powered through a power supply (i.e. a battery). The battery may be rechargeable or disposable. In some embodiments, unit 103 is configured to selectively transmit identifier 105 in an effort to lengthen its battery life. The user may manually activate unit 103 to transmit identifier 105 (i.e. push a button) or unit 103 may be programed to automatically transmit identifier 105 at selected intervals. Although unit 103 has been described as transmitting identifier 105, it is understood that unit 103 may also be configured to receive communication or signals from unit 107 or other devices in system 101. In this way, battery life may be extended wherein unit 103 awaits to transmit identifier 105 until it receives a signal from unit 107 indicating that a compatible electronic unit within system 101 is in the proximity.

A feature of unit 103 is that it may be independent of phone 127 and computer 129. Typically each IOT device creates its own application that is run or controlled through phone 127 and/or computer 129. Phones 127 and computers 129 may become littered with multiple applications to run each of the various different control units. Multiple applications tend to clutter the electronic device and use extra power, therefore decreasing battery life. Unit 103 is ideally suited to be independent of phone 127 and computer 129, wherein identifier 105 is transmitted and control units 107 either have the preference stored or seek the preferences from system provider 109. Adjustment of preferences or personal information is performed at a single interface through user portal 121.

A user portal 121 is an internet or network interface through which the user can gain access to system provider 109 to establish one or more user identifiers 105 and select one or more user preferences for storage in databases 115. User identifier 105, or an identifier that is associated with unit 103, can be manually entered by the user using user portal 121 as discussed above. This may occur direction through unit 103 when unit 103 is phone 127 or computer 129, or other electronic device, for example. User identification unit 103 may, in addition, communicate with system provider 109 using any wireless or wired communication methods, such as the Internet, Ethernet, WI-FI, BLUETOOTH or any other electronic means of communication. User identification unit 103 may communicate additional information with control unit 107, such as a system provider address. Providing the system provider address can aid in differentiating between multiple system provider services, usually competitor services, accelerating the successful search for user identifier 105.

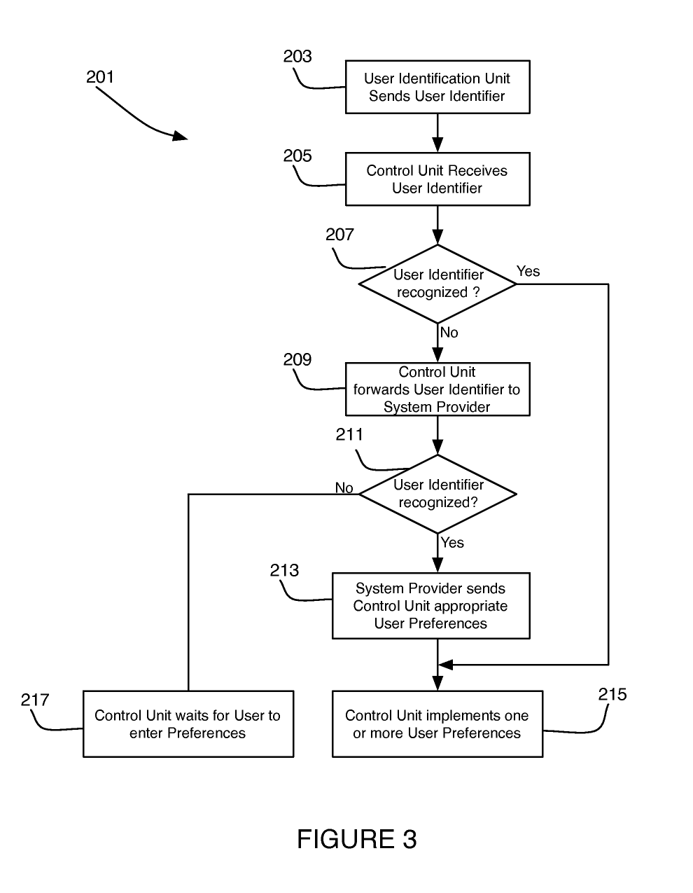

Control unit 107 is configured to receive identifier 105 from unit 103 and selectively initiate a predetermined task or function as a result. The broadcasting identifier 105 may consist of, but is not limited to, a hexadecimal number or alphanumeric phrase, that is unique. Control unit 107 may function in a couple different methods (open and closed). First, control unit 107 may be configured so as to not store any user preferences (open method). In this method, when unit 107 receives identifier 105, it is required to communicate with system provider 109 to verify the identity and access the needed preferences. This naturally relies upon a quick network connection and lag may be experienced. Secondly, control unit 107 is configured to store selected user preferences locally within unit 107 itself (closed method). This allows for quicker initiation of the task when identifier 105 is detected. Selection of either method may depend on the type of control unit 107. Control units in public places (i.e. hotel rooms) may elect to use an open method where control unit 107 has to communicate over a network with system provider 109 each time identifier 105 is detected. Whereas control units in private locations (i.e. homes) where only a selected few users would enter may elect to use a closed system where the preferences are pre-stored on unit 107. More detailed explanations of these two methods are shown and described in relation to FIG. 3 below.

Supplier 123 is configured to communicate with one or more control units 107, providing installation, maintenance, software, or other operational necessities to control unit 107. A supplier may be a manufacturer, hardware installer, software provider, operator, operating contractor or any other entity that is contributes to the operation of control unit 107. Supplier 123 can communicate with system provider 109 to obtain platform independent programming instructions which is distributed to control unit 107, enabling control unit 107 to communicate with system provider 109. JavaScript is one example of a platform independent programming code that may be used. This allows control unit 107 to communicate with various types of operating systems and platforms associated with unit 103 and system provider 109. Supplier 123 may obtain the platform independent programing in various ways for inclusion within unit 107. For example, supplier 123 may be given it freely without restriction, may need to engage in a license restricting the access of user preferences, may need to pay a one-time fee, or some combination thereof. Supplier 123 helps to maintain and set up control unit 107 so as to be able to operate within system 101.

Control unit 107 communicates with system provider 109 to obtain access to one or more databases 115. System provider 109 includes an access manager 119, a user identification list 113, and one or more databases 115. In order to access a user's preferences stored on databases 115, control unit must pass through access manager 119. Manager 119 is configured to regulate the access of units 107 and other electronic devices to identification list 113 and databases 115. Each unit 107 may access only those preferences with which it is designed to initiate. For example, a home device is not allowed to reach the preferences of the user outside the home that might be encountered while traveling, unless permission is acquired. Access manager 119 can allow the user preferences to be transmitted or obtained in various ways. For example, communication with system provider 109 may be done free without restriction, by the issuance of a license restricting the use of user preferences, or through a charged fee, or some combination thereof. Access to user preferences can be to one or more databases as access manager 119 allows and as unit 107 is able to initiate and perform.

User identification list 113 is a compilation of each user having a unique identifier 105. Access manager verifies the identifier 105 from unit 107 corresponds to a registered identifier in list 113. If there is a match, then unit 107 may access the necessary preferences in databases 115 for that user. List 113 is also configured to include a user profile where the user may adjust settings on how system provider 109 is to operate with various control units 107. For example, a user may elect to selectively block/unblock control units from selected locations or that perform selected tasks.

Databases 115 are configured to store particular user preferences. Databases may be segregated and organized in various ways. For example, databases 115 may be separated into a plurality of individual databases that can be categorized by location or by tasks they perform. One categorization example for organizing preferences is a home database 131, a shopping database 133, a health database 135 and a travel database 137. Control unit 107 communicates identifier 105 with system provider 109 in an effort to reach the user preferences. Although separate databases 131-137 have been shown as each having preferences to different task and/or locations, it is understood that database 115 may include any number of databases and that the described categorization is exemplary in nature.

Each preference is a unique dataset of information that may be stored in one or more different formats. The formats may include JSON, XML, or others for example. The dataset does not have to be relational and may be free form data. The data of each dataset is contained within its respective database. For example, datasets related to home devices are contained in database 131, datasets for travel are included in database 137, and so forth. The data may include personal information that may be sensitive in nature or non-sensitive. For example, in health database 135, a user may have their weight included in database 135 for communication with different workout machines. This data may be sensitive in nature. Preferences are datasets that convey information related to an option. For example, in the same workout example, the preference would be the communication of the speed the treadmill should be set at and possibly the time to run. Each of these pieces of information are optional according to the user's desire or preference, whereas personal information is based on a characteristic of the user.

Referring now also to FIG. 3 in the drawings, method 201 illustrates the interaction between user identification unit 103, control unit 107 and system provider 109 to provide the seamless implementation of user preferences. User identification unit 103 transmits user identification 105 in step 203. Control unit 107 receives user identifier 105 in step 205. Control unit 107 then processes user identifier 105 in step 207 and checks whether user identifier 105 matches any user identifiers known to it. If there is a match, control unit 107 implements one or more of the user preferences as seen in step 215. This illustrates the closed system method where the preferences are stored on control unit 107 itself. However, if in step 207, user identifier 105 is not known to control unit 107, then in step 209, control unit 107 communicates with system provider 109 to gain access to the user preferences. System provider 109 checks user identification list 113 for a match to user identification 105 in step 211. If there is no match, then control unit 107 waits for user to enter preferences directly as seen in step 217. If there is a match then system provider 109 sends control unit 107 the user preferences (see step 213) and control unit 107 implements one or more user preferences in step 215. This is an illustration of the open method described previously wherein control unit 107 is required to access system provider 109 via the network to receive the user preferences.

It is understood that system 101 may be configured to operate with both the closed and open methods. Additionally, each control unit 107 may be configured to operate in both methods concurrently wherein some preferences are stored locally on unit 107 for regular users and unit 107 will also follow the open method for new users when detected. Furthermore, unit 107 may be configured to store selected preferences when no identifier is detected. For example, when the user is not around. In this example, the A/C for the home may automatically adjust its settings depending on when the user leaves or arrives. This overcomes the pre-scheduling when the A/C settings should change.

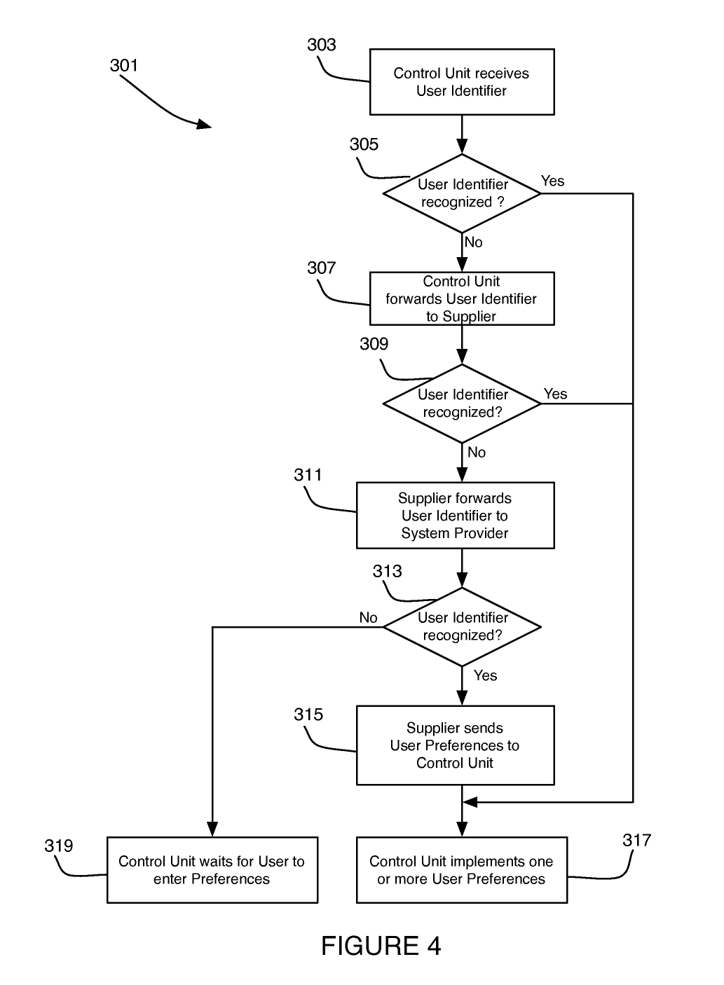

Referring now also to FIG. 4 in the drawings, method 301 illustrates the interaction between user identification unit 103, control unit 107, supplier 123 and system provider 109. Method 301 is similar in process to method 201, except supplier 123 is integrated into the process. In step 303 user identifier 105 is received by control unit 107. In step 305, if control unit 107 recognizes user identifier 105, then control unit 107 implements one or more user preferences in step 317. In step 305, if control unit 107 does not recognize user identifier 105, then in step 307 control unit 107 forwards user identifier 105 to supplier 123. In step 309, if supplier 123 recognizes user identifier 105 then supplier 123 sends user preferences to control unit 107. Therefore, control unit 107 implements one or more user preferences as seen in step 317. In step 309, if supplier 123 does not recognize user identifier 105, then supplier 123 communicates with system provider 109 to gain access to the user preferences (step 311). In step 313, if system provider 109 does not recognize user identification 105, then control unit 107 waits for user to enter user preferences (step 319). In step 313, if system provider 109 recognizes user identifier 105 then system provider 109 transmits (step 315) user preferences to supplier 123 which, in turn, transmits user preferences to control unit 107. Next, in step 317, control unit 107 implements one or more user preferences. Method 301 is advantageous when one or more control units 107, all associated with one supplier 123, require user preferences, system provider 109 only needs to provide user preferences to one source. Additionally, the user may manage the preferences through supplier 123. It is understood that if supplier 123 does not recognize identifier 105, unit 107 may alternatively communicate with system provider 109 for the receipt of user preferences as opposed to involving supplier 123.

The current application has many advantages over the prior art including at least the following: (1) seamless implementation of user preferences; (2) system allows control units of different manufacture to implement common user preferences; (3) control unit access to system provider user preferences may be for a fee or free, as determined by the access manager; and (4) the user's preferences are under control of the user; and (5) identification member broadcasts the unique identifier independent of a person's cell phone or laptop.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. The examples as outlined within this document are just a few of the many possible forms that the system could be implemented. It is important to note that the system is not limited to just these forms, but is amenable to various changes and modifications without departing from the spirit thereof.

What is claimed is:

1. A network communication system, comprising:
a user identification unit configured to identify a user with a particular user identifier, the user identification unit configured to transmit the user identifier;
a control unit configured to receive the user identifier and selectively initiate an action as a result of one or more user preferences; and
a system provider configured to store the one or more user preferences, the system provider in communication with the control unit to associate the one or more user preferences with the user identifier, the system provider categorizing the one or more user preferences into one or more databases;
wherein the one or more user preferences of the user are automatically initiated by the control unit when the control unit receives the user identifier.

2. The network communication system of claim 1, wherein the identification unit is a wireless device.

3. The network communication system of claim 1, wherein the user identification unit communicates with the system provider to establish the unique user identifier with the one or more user preferences.

4. The network communication system of claim 1, wherein the user identification unit communicates a system provider address to the control unit.

5. The network communication system of claim 1, wherein the control unit receives programming instructions from a supplier to communicate with system provider.

6. The network communication system of claim 5, wherein the supplier communicates the one or more user preferences to a plurality of control units.

7. The network communication system of claim 5, wherein the supplier obtains access to the system provider.

8. The network communication system of claim 1, wherein the programming instructions facilitates the control unit to operate platform independent.

9. The network communication system of claim 1, wherein the control unit automatically queries the system provider to access the one or more user preferences associated with the unique user identifier.

10. The network communication system of claim 1, wherein the control unit queries the system provider to access the one or more user preferences associated with the unique user identifier upon request of the user.

11. The network communication system of claim 1, wherein system provider communicates a system provider address to the user identification unit.

12. The network communication system of claim 1, wherein the control unit communicates with the system provider to obtain access to the one or more databases.

13. The network communication system of claim 12, wherein access is obtained through the purchase of a license.

14. The network communication system of claim 12, wherein access is obtained through a one-time payment.

15. The network communication system of claim 12, wherein access is provided independently for each of the one or more databases in the system provider.

16. The network communication system of claim 1, wherein system provider maintains a user portal for permitting the user to manage the one or more user preferences.

17. The network communication system of claim 1, wherein the system provider maintains a list of unique user identifications.
